(19) United States
(12) Patent Application Publication
(10) Pub. No.: US 2012/0003723 A1
(43) Pub. Date: Jan. 5, 2012

(54) Method for Treating and Dispersing Animal Waste

(75) Inventors: MAX CHIRA, Hollywood, FL (US); JEFFREY TRAUTMAN, Hollywood, FL (US); JAMES O'BRIEN, North Miami, FL (US)

(73) Assignee: HOLLYWOOD VENTURES, LLC, Hollywood, FL (US)

(21) Appl. No.: 13/049,280

(22) Filed: Mar. 16, 2011

Related U.S. Application Data
(60) Provisional application No. 61/360,223, filed on Jun. 30, 2010.

(51) Int. Cl. A62D 3/30; A62D 3/02

(52) U.S. Cl. 435/262.5; 588/313

(57) ABSTRACT

A method of dispersing animal waste includes providing an delivery article for holding a treatment agent, said article constructed and arranged with a source of pressurized gas that forces a treatment agent through an outlet of the delivery article and covers animal waste such that the physical pressure of liquid delivery combined with the chemical composition of the treatment agent is effective in dispersing animal waste.

### CROSS-REFERENCE TO RELATED APPLICATIONS

This application claims benefit to U.S. Provisional Patent No. 61/360,223 filed Jun. 30, 2010, the disclosure of which is incorporated herein by reference in its entirety.

### BACKGROUND OF THE INVENTION

### Field of the Invention

The present invention relates to the dispersal and neutralization of feces. More particularly, canine feces is contemplated, although the present invention may be utilized with other fecal matter.

### SUMMARY OF THE INVENTION

When addressing the need to treat feces, there are physical and chemical concerns to be addressed. On a physical and/or physiological level, feces is subject to colonic water re-adsorption prior to being expelled from an animal. This removal of water favors the formation of complex intermolecular bonds, often carbon-carbon single and double bonds that manifest themselves as a rigid solid structure. These bonds must be broken in order to effectively disperse fecal matter. Additionally, there are nitrates, phosphates, potash, indoles, bacteria, organic residues relating to diet, volatile organic compounds (VOC) and various aromatic and aliphatic organic compounds. If one were to merely disperse the fecal solid, the various chemical components would still be present and create a health risk.

The present invention addresses the need for safely treating feces by providing physical dispersion of the fecal matter while also applying a chemical treatment for neutralizing odor, harmful bacteria, and chemical components.

It has also been discovered that the treatment agent of the present invention treat chemical, physical, and biological aspects of urine. Although urine does not require the same physical dispersion as feces, urine still poses a threat as a carrier of chemical and biological contaminants. There is also a need on a molecular level to break up molecules, compounds, and complexes that exist within the urine composition.

As in feces, the treatment agent of the present invention is a chemical treatment for neutralizing odor, harmful bacteria, and chemical components of urine.

### BRIEF DESCRIPTION OF THE SEVERAL VIEWS OF THE DRAWING

FIG. 1 is a side cross section view of the sprayer.

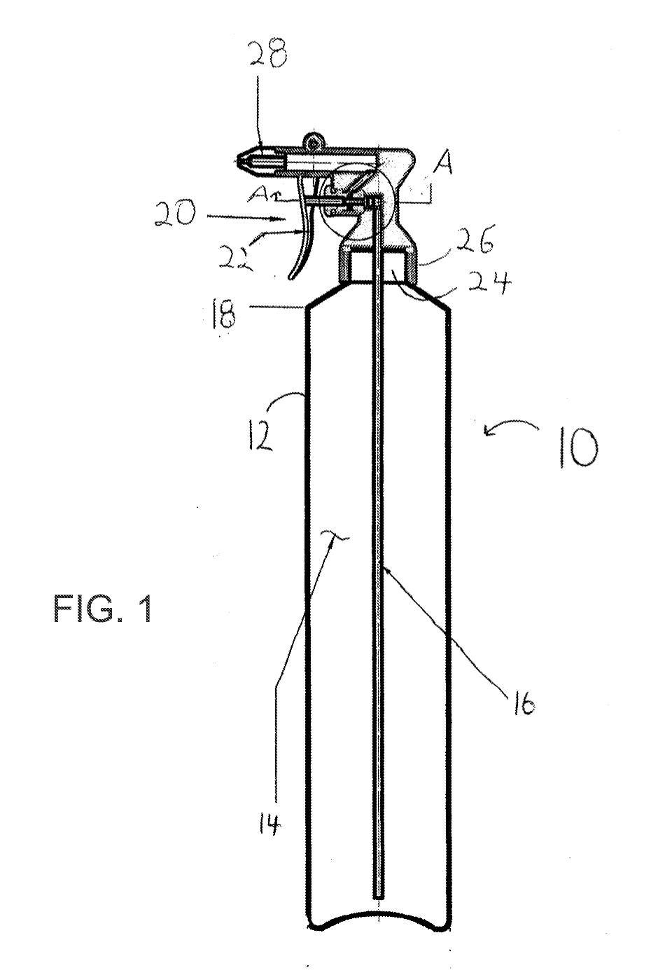

FIG. 2 is a partial side cross section along lines A-A from FIG. 1.

FIG. 3 is a front view showing a two-chambered sprayer arrangement.

### DETAILED DESCRIPTION OF THE PREFERRED EMBODIMENT

The present invention relates to a high-pressure rechargeable sprayer system used to disinfect and neutralize harmful chemicals, bacteria, and microbes in pet waste.

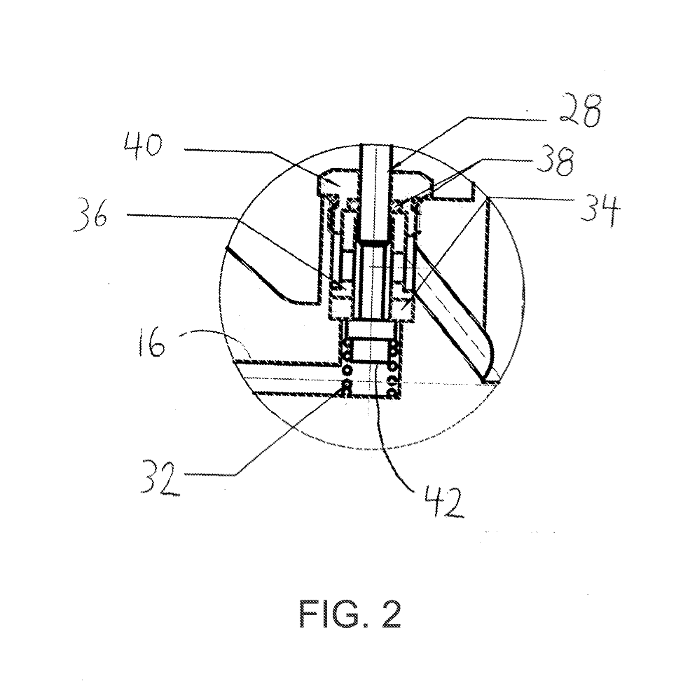

Delivery article 10 has a circumferral wall 12 defining an inner cavity 14. Hollow dispensing tube 16 has a first open end in said inner cavity 14 and attaches to spray mechanism 20 affixed along upper end 18 of sprayer 10 through connection at neck 24 constructed and arranged to attach with sprayer attachment 26. Spray mechanism 20 has an actuating trigger 22 that releases pressurized treatment agent contained in article 10 through outlet nozzle 28. In one embodiment, as shown in FIG. 2, spray mechanism 20 has a first spring 32 that urges release mechanism 42 into a closed position. Actuation of trigger 22 compresses spring 32 and allows release of the treatment agent contained in article 10. First sealing washer 34 and second sealing washer 36 are constructed and arranged to seal the treatment agent within article 10 when a propellant gas is contained within article 10. An O-ring 38 an sealing nut 40 further provide for holding the treatment agent and propellant within article 10 until released by trigger 22.

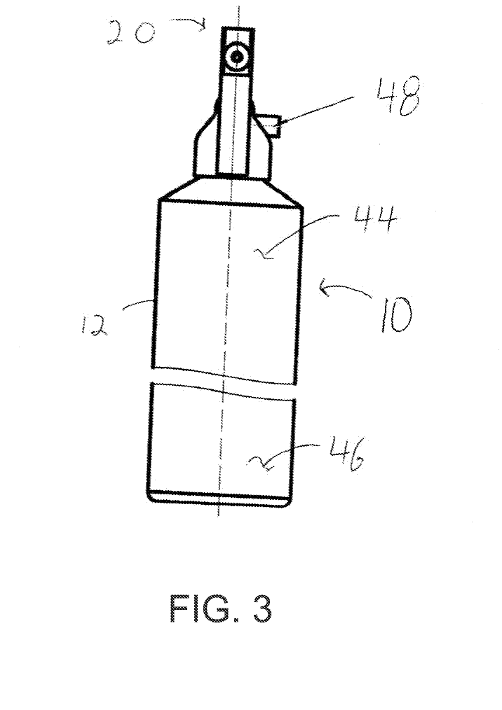

Article 10 is constructed and arranged to be user refillable and a recharge valve 48 is provided for refilling treatment agent and propellant into article 10. In one embodiment, treatment agent and propellant are in a single interior cavity 14. In another embodiment, as seen in FIG. 3, article 10 has a first chamber 44 and a second chamber 46 for separately holding treatment agent and propellant.

The method of the present invention contemplates providing a delivery article constructed and arranged such that the article can hold within a source of pressurized gas and a treatment agent. The treatment agent can be a gas or liquid. The pressurized gases are held in the delivery article in a manner such that the pressurized gas will force the treatment agent through an outlet of the delivery article.

The present invention contemplates utilizing any suitable pressurized gas. Suitable pressurized gas may include, but would not be limited to pressurized ambient air, nitrogen, carbon dioxide, and the like.

The delivery article of the present invention is contemplated to be reusable. Thus, when the pressurized gas contained within the delivery article has been expended, the delivery article is constructed and arranged such that a refill of pressurized gas is easily performed.

In a preferred embodiment, pressurized gas exiting the delivery article of the present invention is in the range of 50-300 pounds per square inch (psi). In another preferred embodiment, the pressurized gas exiting the delivery article of the present invention is in the range of 150-200 psi.

The delivery article of the present invention is constructed and arranged with suitable chambers for holding each of a treatment agent according to the present invention and a pressurized gas. In one embodiment, the treatment agent and pressurized gas may be held in a single chamber. However, the delivery article of the present invention may be constructed and arranged such that there are separate chambers for holding each of the treatment agent and pressurized gas.

In keeping with the contemplated reusability of the delivery article of the present invention, when a liquid treatment agent is used, the liquid chamber of the delivery article is contemplated to be easily refillable.

The pressurized gas, along with the treatment agent, breaks up the animal waste into smaller pieces. The breaking up of the animal waste would occur regardless of any liquid applied with the pressurized gas. However, the present invention breaks up the waste and the provides significantly increased surface area that facilitates application of a treatment agent. The treatment agent does at least one of neutralize odor, kill bacteria, and neutralize harmful chemicals.

The treatment agent of the present invention is contemplated to be a non-toxic item. The treatment agent is contemplated to be in liquid form. The term liquid, as used herein, is used to describe any solution, suspension, emulsion, or other liquid like substance, including combinations of the aforementioned.

The treatment agent comprises an active component which is either a single compound or a combination of materials that perform the desired chemical interaction with animal fecal waste. Additionally the treatment agent has the desired interaction with urine.

As used herein, the term non-toxic, refers to a treatment agent that may be applied directly on the ground and not create an aggregate or cumulative adverse environmental effect.

Preferred treatment agents include ionic metal compounds, and nitrates, sulfates, and phosphate thereof. Further contemplated treatment agents include hydrated forms of the aforementioned as well as any combinations of the aforementioned compounds. The treatment agent can further include emulsifiers, suspending agents, solubilizers, chelating agents, fillers, inorganic solvents, organic solvents, and combinations thereof.

In a preferred embodiment, the treatment agent of the present invention utilizes a solution containing copper sulfate pentahydrate.

In one embodiment, the treatment agent contains a commercially available product sold under the name Evicol (Envirogreen Global Solutions, Miami, Fla.). As set forth herein, the treatment agent is present to neutralize odor and kill bacteria in animal waste and the treatment agent is more effective when the animal waste is broken into smaller pieces using the compressed gas of the present invention.

In another embodiment, the treatment agent is a blend of which are selected and formulated from known materials used for treating fecal matter. These can be from septic treatment science and can also include other materials, including enzymes, bacteria, and surfactants not currently used in the septic industry. It is contemplated that any combination of materials be safe in accumulation amounts to not have any adverse effect on soil and groundwater. This would include, but not be limited to, compositions selected and formulated to provide enhanced symbiotic effects based on chemical interaction of selected components.

Other materials associated with sapotrophic materials are also suitable in the present invention. Saprotrophic compounds are a class of compounds some of which are also suitable in septic treatment applications. The class also includes compounds not suitable for septic use. These include, but are not limited to soil saprophytic materials and compounds.

In one embodiment, the treatment agent is an aqueous solution having a concentration of active compound in the range of about 0.0005-1.10% w/w.

In use, the present invention is a method of disbursing and treating animal waste.

A user is provided a delivery article constructed and arranged with at least one chamber for holding a pressurized gas and a treatment agent. The treatment agent is selected based on the ability to provide chemical interaction with fecal matter and provide neutralization of odor, destroy harmful bacteria, assist in the degradation of feces, and exhibit a shelf-life of up to one year when stored under pressure.

The delivery article further constructed and arranged with an actuator, at least one inlet for filling with a gaseous propellant and a treatment agent. As stated herein, treatment agent may be liquid, gaseous, or combinations thereof.

The delivery article has an outlet for pressurized delivering of the treatment agent from said delivery article.

The method includes providing a pressurized gas to the treatment article. It is contemplated that the treatment article is user fillable and may include additional implements to import gas to the interior of the delivery article.

providing a treatment agent;

placing said pressurized gas and treatment agent in said delivery article;

aiming said outlet any desired direction, wherein said desired direction is a location in which animal waste is present;

initiating delivery of said pressurized gas and said treatment agent by operation of said actuator;

applying said outlet of said pressurized gas and said treatment agent onto said animal waste.

The method of the present invention provides for not only the physical breaking of complex intermolecular bonds that bind feces into a recognizable solid, but chemical treatment that provides for neutralization of odor, bacteria, other harmful components. and combinations thereof. The animal waste is feces, urine, or a combination thereof.

In one embodiment of the present invention, a method is provided wherein a delivery article is provided. The providing of the delivery article includes providing a delivery article for the pressurized delivery of a substrate contained within the delivery article. The delivery article us user refillable for each of a pressurized gas and a delivery substrate. In this embodiment, the delivery substrate may be any substance that is desired to be delivered in concert with a pressurized gas.

The method includes delivering a substrate to a treatment article and comprises:

providing a delivery article constructed and arranged with at least one chamber for holding a pressurized gas and a treatment agent, said delivery article further constructed and arranged with an actuator and an outlet for delivering said treatment agent from said delivery article;

providing a pressurized gas;

providing a treatment agent;

placing said pressurized gas and treatment agent in said delivery article;

aiming said outlet in any desired direction, wherein said desired direction is a location in which a treatment agent disposition is desired;

initiating delivery of said pressurized gas and said treatment agent by operation of said actuator;

applying said outlet of said pressurized gas and said treatment agent onto an article in said location.

The pressurized gas is between 150-200 psi when placed in said delivery article.

The treatment agent comprises any substance to be delivered concurrently with pressurized gas and is selected based on composition of matter in said desired location.

The treatment agent is aqueous, organic, or combinations thereof and is used to treat a solid, semisolid, or liquid.

In a preferred embodiment, the treatment agent is used to treat, react with, or otherwise neutralize a chemical or biological substance which is the article in a location to be treated.

The treatment agent is a solid, semisolid, liquid, gas, or combinations thereof and is applied concurrently with said pressurized gas provides physical and chemical treatment of a chemical or biological substance.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

We claim:

1. A method of treating and dispersing animal waste comprising the steps of:
a. providing a delivery article constructed and arranged with at least one chamber for holding a pressurized gas and a treatment agent, said delivery article further constructed and arranged with an actuator and an outlet for delivering said treatment agent from said delivery article;
b. providing a pressurized gas;
c. providing a treatment agent;
d. placing said pressurized gas and treatment agent in said delivery article;
e. aiming said outlet any desired direction, wherein said desired direction is a location in which animal waste is present;
f. initiating delivery of said pressurized gas and said treatment agent by operation of said actuator;
g. applying said outlet of said pressurized gas and said treatment agent onto said animal waste.

2. The method of claim 1, wherein said pressurized gas is between 25-40 psi when placed in said delivery article.

3. The method of claim 1, wherein said treatment agent comprises copper sulfate, enzymes, bacteria, saprotropic components, saprophytic components, or combinations thereof.

4. The method of claim 1, wherein said treatment agent is a composition free of adverse cumulative effect on soil and groundwater.

5. The method of claim 1, further comprising substantial elimination of odor from animal waste after said applying of treatment agent.

6. The method of claim 5, wherein said elimination of odor includes a lack of perceived odor from a distance of four feet from said animal waste, sixty seconds after said applying of treatment agent.

7. The method of claim 1, further comprising the killing of fecal-based bacteria upon applying said treatment agent on said animal waste.

8. The method of claim 7, wherein said killing of bacteria is measured as total and fecal coliform bacteria.

9. The method of claim 8, wherein said killing of bacteria comprises greater than 99% of said bacteria killed within 5 minutes of said applying of said treatment.

10. The method of claim 1 wherein said treatment agent has a concentration of active in the range of 0.0005 -1.150% w/w.

11. The method of claim 1 wherein said animal waste is feces, urine, or combinations thereof.

12. A method of delivering a substrate to a treatment article comprising:
a. providing a delivery article constructed and arranged with at least one chamber for holding a pressurized gas and a treatment agent, said delivery article further constructed and arranged with an actuator and an outlet for delivering said treatment agent from said delivery article;
b. providing a pressurized gas;
c. providing a treatment agent;
d. placing said pressurized gas and treatment agent in said delivery article;
e. aiming said outlet in any desired direction, wherein said desired direction is a location in which a treatment agent disposition is desired;
f. initiating delivery of said pressurized gas and said treatment agent by operation of said actuator;
g. applying said outlet of said pressurized gas and said treatment agent onto said location.

13. The method of claim 12, wherein said pressurized gas is between 150-200 psi when placed in said delivery article.

14. The method of claim 12, wherein said treatment agent comprises any substance to be delivered concurrently with pressurized gas.

15. The method of claim 12, wherein said treatment agent is selected based on composition of matter in said desired location.

16. The method of claim 12, wherein said treatment agent is aqueous, organic, or combinations thereof.

17. The method of claim 12, wherein said treatment agent is used to treat a solid, semisolid, or liquid.

18. The method of claim 12, wherein said treatment agent is used to treat, react with, or otherwise neutralize a chemical or biological substance.

19. The method of claim 12, wherein said treatment agent is a solid, semisolid, liquid, gas, or combinations thereof.

20. The method of claim 12, wherein said treatment agent applied concurrently with said pressurized gas provides physical and chemical treatment of a chemical or biological substance.
